(19) United States
(12) Patent Application Publication
(10) Pub. No.: US 2017/0174163 A1
(43) Pub. Date: Jun. 22, 2017

(54) OCCUPANT PROTECTION METHOD AND OCCUPANT PROTECTION DEVICE OF A VEHICLE

(71) Applicant: Robert Bosch GmbH, Stuttgart (DE)

(72) Inventors: Andreas KORTHAUER, Stuttgart (DE); Armin RUEHLE, Weinstadt (DE); Armin KOEHLER, Sachsenheim (DE); Christian MOTZ, Yokohama-Shi Kanaga (JP); Gian Antonio D'ADDETTA, Stuttgart (DE); Heiko FREIENSTEIN, Weil Der Stadt (DE); Sybille EISELE, Hessigheim (DE); Volker HOFSAESS, Moeglingen (DE)

(21) Appl. No.: 15/316,345

(22) PCT Filed: May 22, 2015
(86) PCT No.: PCT/EP2015/061406

§ 371 Date: Dec. 5, 2016

(30) Foreign Application Priority Data
Jun. 3, 2014 (DE) 10 2014 210 494.7

(51) Int. Cl. B60R 21/0134

(52) U.S. Cl. CPC B60R 21/0134; B60R 2021/01034

(57) ABSTRACT

A method is described for operating a vehicle, including the following steps: ascertaining a collision probability for the vehicle, ascertaining an effectiveness parameter assigned to a restraint system of the vehicle, which is a measure of how effectively the restraint system may protect a vehicle occupant in the event of a collision assigned to the collision probability, and carrying out at least one injury-mitigating measure depending on the ascertained effectiveness parameter in order to mitigate an occupant injury during a collision. Also described are a corresponding device and a computer program.

### FIELD OF THE INVENTION

The present invention relates to a method and to a device for operating a vehicle. The present invention further relates to a computer program.

### BACKGROUND INFORMATION

Vehicles generally include a restraint system which is intended to protect vehicle occupants in the event of a collision. In this case, the known restraint systems are generally designed in such a way that a maximum possible protection for the vehicle occupants is given only when the vehicle occupants assume a predetermined position. If the vehicle occupants no longer assume this predetermined position, a protective effect of the restraint systems could be reduced. The vehicle occupants would then no longer be optimally protected during a collision.

### SUMMARY

An object underlying the present invention is to provide a method for operating a vehicle, which makes it possible to mitigate injury to an occupant of a vehicle during a collision even if the vehicle occupant assumes different positions.

The object underlying the present invention may also be to provide a corresponding device for operating a vehicle.

The object underlying the present invention may also be to provide a corresponding computer program.

According to one aspect, a method for operating a vehicle is provided, including the following steps:
ascertaining a collision probability for the vehicle,
ascertaining an effectiveness parameter assigned to a restraint system of the vehicle, which is a measure of how effectively the restraint system may protect a vehicle occupant in the event of a collision assigned to the collision probability, and
carrying out at least one injury-mitigating measure depending on the ascertained effectiveness parameter in order to mitigate occupant injury during a collision.

According to yet another aspect, a device for operating a vehicle is provided, the device being configured or designed for carrying out the method for operating a vehicle.

According to one further aspect, a computer program is provided, which includes program code for carrying out the method for operating a vehicle when the computer program is run on a computer.

According to yet another aspect, a vehicle is provided, which includes the device according to the present invention.

Ascertaining the effectiveness parameter yields the technical advantage, in particular, that it is possible to estimate how effectively the restraint system may protect a vehicle occupant in the event of a collision assigned to the collision probability. The situation is therefore advantageously taken into account, in which a restraint system may not necessarily protect equally well, but rather to different extents, in different situations. If it is therefore established that the restraint system may no longer optimally protect the vehicle occupant in the event of a collision, an injury-mitigating measure is carried out.

An injury-mitigating measure within the scope of the present invention refers, in particular, to a measure which is suitable for mitigating occupant injury during the collision. The measure may be preferably carried out before the collision. In particular, the measure may be carried out in the event of the collision. Preferably, multiple measures are provided, which are designed to be the same, in particular, or, for example, different.

When reference is made to a vehicle occupant above and in the following, the plural is also intended in every case. The comments made above and in the following apply similarly in the case of multiple vehicle occupants. The vehicle occupant may be, for example, the driver of the vehicle. The vehicle occupant may be, for example, a passenger of the driver. The vehicle occupant may sit in a front seat or in a back seat.

According to one specific embodiment, it is provided that a vehicle interior state of a vehicle interior is detected and the effectiveness parameter is ascertained on the basis of the detected vehicle interior state. This yields the technical advantage, in particular, that the injury-mitigating measure is carried out depending on the vehicle interior state. This is the case because a restraint system usually has different levels of effectiveness in different vehicle interior states. When an object is located in the inflation area of an airbag, for example, the airbag may no longer optimally protect the vehicle occupant during a collision and a resultant inflation of the airbag. Rather, there is the risk here that, due to the inflation, the object will be propelled in the direction of the vehicle occupant and could injure the vehicle occupant.

In another specific embodiment, it is provided that a vehicle occupant state of the vehicle occupant is detected and the effectiveness parameter is ascertained on the basis of the detected vehicle occupant state. This yields the technical advantage, in particular, that the injury-mitigating measure is carried out depending on a vehicle occupant state. This is the case because, depending on the state of the vehicle occupant, a restraint system may protect this occupant to a more or less greater extent in the event of a collision. If a vehicle occupant turns away from an inflation area of an airbag, for example, this airbag may generally no longer protect the vehicle occupant in the event of a collision and a resultant inflation to as great an extent as in the case in which the vehicle occupant faces the inflation area of the airbag. In addition, an airbag or a seat belt tightener, for example, may no longer deploy its optimal protective effect if the vehicle occupant is lying curled-up in his vehicle seat, or has placed his feet on the dashboard. Such a state is therefore classified as a state in which a restraint system may no longer optimally protect the vehicle occupant in the event of a collision.

According to another specific embodiment, it is provided that a dynamic vehicle parameter is detected and the effectiveness parameter is carried out on the basis of the detected dynamic vehicle parameter. This yields the technical advantage, in particular, that the injury-mitigating measure is carried out depending on the dynamic vehicle parameter. A dynamic vehicle parameter may be, for example, a vehicle speed, a vehicle acceleration, a vehicle deceleration, or a vehicle position. Preferably, multiple dynamic vehicle parameters are provided, which may be one of the aforementioned vehicle parameters. In the case of multiple vehicle parameters, these are designed to be the same, in particular, or preferably different.

It is therefore possible, in particular, to advantageously account for the situation in which a restraint system does not need to protect as effectively at vehicle speeds such as those which usually occur during a traffic jam as they do at a vehicle speed which is considerably higher than a vehicle speed during a traffic jam. A vehicle speed during a traffic jam usually lies between 0 kilometers per hour and 8 kilometers per hour. A substantially higher speed usually lies in the range of 40 kilometers per hour or more. Depending on a vehicle speed, certain occupant positions may also be permitted, for example, without an injury-mitigating measure being carried out as a result, such an occupant position not being permitted otherwise.

In another specific embodiment, it is provided that, as an injury-mitigating measure, an airbag is deactivated or is inflated during the collision with dynamics which are less than a predetermined dynamics threshold value. This yields the technical advantage, in particular, that an airbag may cause no injury or less of an injury to the vehicle occupant due to its deactivation or the inflation with reduced dynamics. This is the case because the airbag may cause greater injury than it would otherwise, for example, depending on a certain occupant position.

In another specific embodiment, it is provided that, during automated driving of the vehicle, a take-over prompt to a driver for the guidance of the vehicle is carried out as an injury-mitigating measure. This yields the technical advantage, in particular, that it is made clear to the driver or the driver is made aware that he should now take over the guidance of the vehicle. The driver himself is therefore enabled once more to guide the vehicle and, for example, to avoid a collision or to take other appropriate measures.

In another specific embodiment, it is provided that the take-over prompt includes an actuation of a driver's seat and/or an actuation of a driver's seat belt. This yields the technical advantage, in particular, that the take-over prompt is immediately communicated to the driver. This is the case because, generally, the driver will immediately and directly and unambiguously notice an actuation of his seat or an actuation of his driver's seat belt. For all intents and purposes, a communication with the driver is effectuated via this actuation. The driver's seat or the driver's seat belt function as a human-machine interface for a communication with the driver.

According to another specific embodiment, it is provided that, via the actuation, the driver is moved into a changed sitting position as compared to a sitting position before the actuation. This yields the technical advantage, in particular, that the driver is moved into a different sitting position and is hereby assisted. The driver may therefore advantageously quickly assume a sitting position which is optimal for the vehicle guidance.

According to one further specific embodiment, it is provided that the take-over prompt includes an extension of foot pedals and/or a steering wheel from a retracted position. This yields the technical advantage, in particular, that the pedals and the steering wheel are directly and immediately available to the driver again for the guidance of the vehicle. He may therefore quickly take over the guidance of the vehicle.

According to one specific embodiment, surroundings of the vehicle are detected, in particular, with the aid of one or multiple surroundings sensors. Such surroundings sensors may be, for example: radar sensors, video sensors, ultrasonic sensors, LIDAR sensors, infrared sensors, or any other type of active optical surroundings sensors. It is preferably provided that the collision probability is ascertained on the basis of the detected surroundings.

According to one specific embodiment, it is provided that a piece of surroundings information is provided to the vehicle, i.e., in particular, is sent to the vehicle, in particular, via telemetry, such as, for example, a mobile communications network, a WLAN, or a communications network. This piece of surroundings information is provided to the vehicle, for example, via another road user or an infrastructure or a traffic service. In particular, multiple pieces of surroundings information may be provided to the vehicle from different senders. It is preferably provided that the collision probability is ascertained on the basis of the surroundings information.

According to another specific embodiment, it is provided that location-specific information resulting from navigation map data is utilized in order to ascertain a collision probability for the vehicle. It is preferably provided that a vehicle position is determined or ascertained, for example, via GPS. The instantaneous vehicle position is preferably compared with map data from a digital map, the map data including information regarding accident risks. This therefore advantageously yields the technical effect that the information regarding whether a particular accident risk exists at this vehicle position may be assigned to a vehicle position.

According to another specific embodiment, it is provided that vehicle-relevant variables, for example, vehicle speed, vehicle external temperature, a risk of icy conditions ascertained on the basis of low traction, a diagnosis of states of components or elements of the vehicle, and movement profiles are used in order to ascertain the collision probability.

In another specific embodiment, it is provided that a user profile of the present driver is utilized in order to ascertain the collision probability on the basis thereof. This means, for example, that the device becomes familiar with the driver in previous trips and creates a profile and an evaluation on the basis of the previous driving pattern. It is preferably provided that the collision probability is ascertained on the basis of the user profile.

In one specific embodiment, a vehicle interior camera is provided. This is preferably utilized for determining or ascertaining a vehicle occupant position, in particular OOP states. In this case, “OOP” stands for “out of position” and refers to a position which deviates from a position in which the restraint system may optimally protect the vehicle occupant. An OOP position may include, for example, a position of the vehicle occupant, in which this occupant has placed his feet onto a dashboard or in which he curls up out on his seat.

In particular, the interior camera is utilized in order to detect objects in the vehicle interior. As a result, it may be ascertained, in particular, which effect of the restraint system may be limited by the detected objects. The effectiveness parameter, in particular, is ascertained depending on a result of the ascertainment.

According to one further specific embodiment, it is provided that a video sensor system and/or an ultrasonic sensor system and/or an infrared sensor system are/is provided, which are/is designed for monitoring a footwell. This yields the technical advantage, in particular, that a position of the feet of the driver or further vehicle occupants may be detected. It may therefore be differentiated, in particular, whether the feet are situated in front of the pedals or whether they were placed up high, i.e., for example, on a dashboard. The effectiveness parameter, in particular, is ascertained depending on a result of the monitoring.

In another specific embodiment, a video sensor system and/or an ultrasonic sensor system and/or an infrared sensor system are/is provided, which are/is designed for detecting a position of hands and/or arms of the driver and/or further vehicle occupants. This therefore yields the technical advantage, for example, that it may be detected whether or not the driver has his hands on the steering wheel. The effectiveness parameter, in particular, is ascertained depending on a result of the detection.

In another specific embodiment, it is provided that a fingerprint identification system is utilized in order to determine a present seat position, in particular, by way of the fingerprint identification system providing a particular starting seat position for the particular driver (a so-called memory seat setting). Seat position sensors in the corresponding vehicle seats provide a delta of this memory seat setting relative to the instantaneous seat position. A present or instantaneous seat position may be advantageously determined from the difference formation between the delta and the memory seat setting. The effectiveness parameter is preferably ascertained based on the presently determined seat position.

In another specific embodiment, it is provided that position settings of one or multiple vehicle seat(s) are detected or ascertained. This, in particular, with the aid of path sensors and/or a detection of movement of the adjusting motors of the vehicle seats. The effectiveness parameter is preferably ascertained on the basis of the position settings.

In another specific embodiment, it is provided that seat belt-extraction sensors and/or further occupant identification and classification sensors are utilized for validation (occupancy detection, weight detection, seat widths, capacitive sensors). It may therefore be validated, for example, whether or not a vehicle occupant is actually situated on a vehicle seat.

In another specific embodiment, it is provided that a “fastened seat belt” state is detected, in particular, with the aid of a seat-belt buckle sensor system and/or a monitoring of an electric motor-operated retractor and/or a monitoring of a seat belt motor and/or a camera-based monitoring, i.e., a monitoring with the aid of a camera. It is therefore detected whether or not a vehicle occupant has fastened the seat belt. The effectiveness parameter is preferably ascertained depending on a result of the detection.

In another specific embodiment, it is provided that an object identification is carried out via RFID, WLAN and/or plug connections in order to validate objects detected, for example, by a camera, and, if necessary, to classify whether or not this object poses a potential risk.

In another specific embodiment, it is provided that a position detection of other vehicle components (for example, pivotable displays or screens, keypads, trays for, for example, food items, steering wheel) located in the vehicle interior is carried out. The effectiveness parameter is preferably ascertained depending on a result of the position detection.

According to one further specific embodiment, it is provided that an age and/or a weight and/or a gender and/or a mass distribution of a driver and/or of further vehicle occupants is/are determined or ascertained with the aid of a suitably designed sensor system. The effectiveness parameter is preferably ascertained depending thereon.

In another specific embodiment, it is provided that a level of distraction of the driver or of a vehicle occupant is measured, in particular, based an interaction by this vehicle occupant with other vehicle occupants and/or other persons outside the vehicle. This measurement is carried out, in particular, with the aid of an analysis of voice characteristics of the vehicle occupant to be measured. In this way, it may be detected, for example, whether this occupant is upset or not. This may be utilized, in particular, for a threshold adaptation, i.e., how soon the injury-mitigating measure is carried out. In this way, the injury-mitigating measure may be carried out, for example, if the corresponding threshold value is less than the effectiveness parameter.

Whether or not an injury-mitigating measure is carried out, for example, may be decided, in particular, with the aid of a risk assessment. The risk assessment may be carried out as follows, for example.

The risk assessment may already be carried out, on the one hand, on the basis of very simple, singular pieces of information, for example:
In the case of a low speed and/or location information at which no higher speeds of potential crash opponents are to be expected (for example, driving in a traffic jam), extensive activities by the driver are permitted (for example, a greatly reclined position of the seat and laptop or other larger objects in the airbag deployment space) and, in the event of a crash, the airbag would not inflate, for example, or only with greatly reduced dynamics, since the restraint effect of the crash suffices for the maximum ascertained crash severity.
On the other hand, preferably in the case of high speeds and/or location information which allows for high speeds, certain activities are absolutely forbidden by the driver (for example, in the case of extreme seat positions, a prompt to adjust the seat is issued and, if the seat is not adjusted, the take-back of the vehicle guidance is demanded).
If it was detected via diagnosis that a certain actuator (for example, a seat adjuster or a reversible seat belt tightener) is not available, the automated driving mode is preferably generally not permitted or is limited.
Whenever hazardous driving states are detected (for example, feet on the instrument panel), the driver is preferably prompted to change his position; otherwise, the take-back of the vehicle guidance is demanded.

The risk assessment may also be, in particular, a complex linkage of comprehensive situation analyses, such as, for example:
If a value is obtained, which is higher than an acceptance threshold, from an exact (for example, model-based) prediction of a presently possible likelihood of injury on the basis of the state variables such as maximum possible crash severity, achievable occupant position or situation at the possible crash instant and the constitution of the occupant and a given probability of a collision, measures which are optimal for the situation must be taken in order to drop below this acceptance threshold again (the acceptance threshold to be based, for example, on the related art without automated driving functions).

For this purpose, different measures are preferably proposed to the driver, which he then selects himself, or the device is so intelligent that it may make the selection itself, i.e., it preferably decides autonomously.

The possible exemplary measures and interventions are as follows, for example:

In the event of a risk which prompts the automated driving system to demand from the driver to take back the driving task, the belt and seat actuators—in addition to the faster positioning—may be utilized as a HMI (human-machine interface) in order to assist the driver, with the aid of suitable impulses, in the rapid detection of the situation, the driver being therefore more quickly capable of taking over the vehicle guidance. In one further specific embodiment, the take-back may also go beyond a mere request (audio signal, haptically, direct announcement etc.) and the occupant may be gently brought into an optimal position with the aid of suitable actuators. This may take place, for example, with the aid of an electric motor-operated seat belt (if the seat belt is fastened), or by moving the seat upright or extending the pedals and steering wheel (from the “hidden” automatic driving position).

According to one specific embodiment, multiple measures are carried out, which are designed to be the same, in particular, or preferably different.

According to one specific embodiment, the vehicle is operated in an automated driving mode. In such a driving mode, the vehicle is guided autonomously, i.e., automatically, without the need for a driver to intervene in the vehicle guidance.

### BRIEF DESCRIPTION OF THE DRAWINGS

FIG. 1 shows a flow chart of a method for operating a vehicle.

FIG. 2 shows a device for operating a vehicle.

FIG. 3 shows a block diagram of a method for operating a vehicle.

FIG. 4 shows a block diagram of a further method for operating a vehicle.

### DETAILED DESCRIPTION

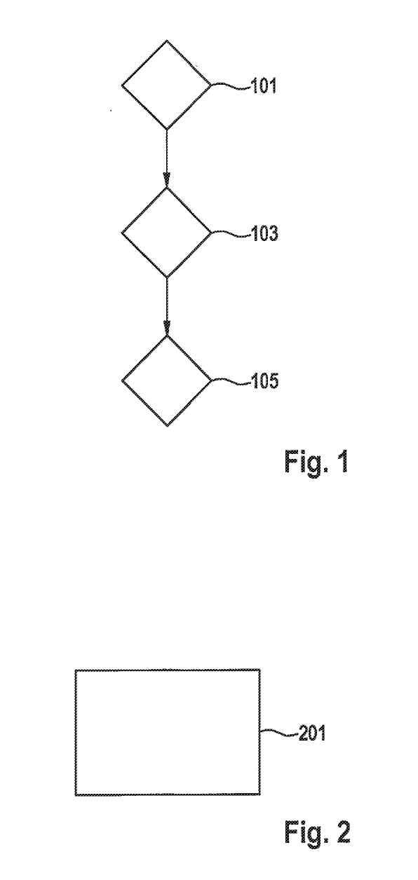

FIG. 1 shows a method for operating a vehicle.

In a step 101, a collision probability for the vehicle is ascertained. In a step 103, an effectiveness parameter is ascertained, which is assigned to a restraint system of the vehicle. The effectiveness parameter is a measure of how effectively the restraint system may protect a vehicle occupant in the event of a collision assigned to the collision probability. In a step 105, at least one injury-mitigating measure depending on the ascertained effectiveness parameter is carried out in order to mitigate occupant injury during a collision.

FIG. 2 shows a device 201 for operating a vehicle. Device 201 is configured or designed for carrying out the method according to the present invention.

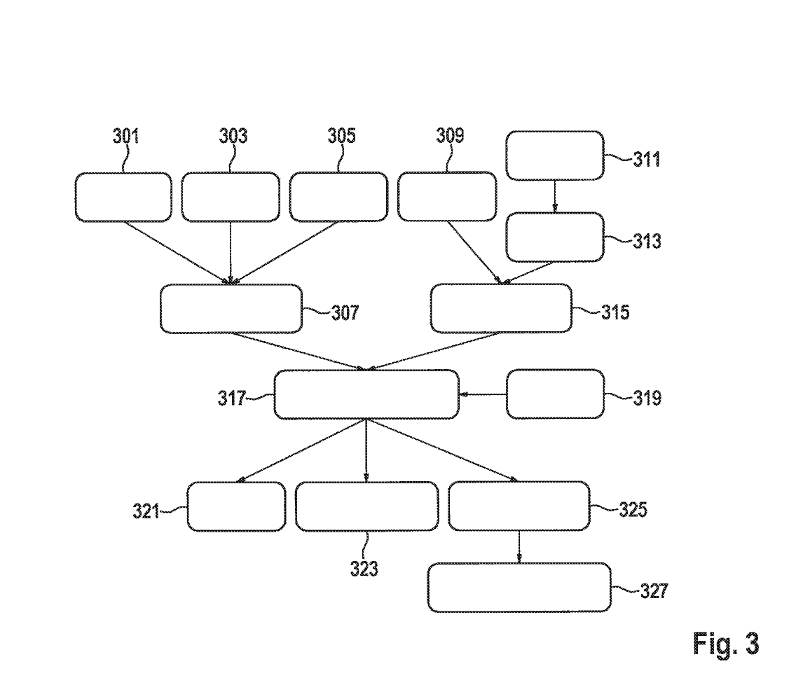

FIG. 3 shows a block diagram of a method for operating a vehicle.

In a step 301, surroundings of the vehicle are detected by sensors with the aid of a surroundings sensor system of the vehicle. In a step 303, a so-called C2X communication takes place. This means that the vehicle receives data from further vehicles. Such further data may be, for example, sensor data from the further vehicles, which correspond to surroundings of these further vehicles and which have been detected by sensors. For example, such further data may be position data regarding the further vehicles. In a step 305, map data from a digital map are provided. The sensor data, the further data, and the digital map data are analyzed in a step 307. In this case, a situation analysis takes place, in particular.

In particular, in step 307, a surroundings model of the vehicle is ascertained or calculated on the basis of the data. The surroundings model is therefore a model of the vehicle surroundings.

In a step 309, a vehicle interior is detected by sensors with the aid of an interior sensor system of the vehicle. In a step 311, a device identification is carried out by devices which are located in the vehicle interior. In a step 313, a device status of the devices ascertained or identified according to step 311 is carried out. The data gathered by the interior sensor system, and the identified devices and the corresponding status are analyzed in a step 315. In this case, a situation analysis of the vehicle interior takes place, in particular. In particular, in step 315, a vehicle occupant model is created. This means that a model which describes a vehicle occupant state is created or ascertained.

In a step 317, a risk assessment takes place on the basis of the surroundings model and the vehicle occupant model. In this risk assessment, it is ascertained, in particular, how effectively the restraint system of the vehicle may protect the vehicle occupants in the event of a collision. This means that an effectiveness parameter is ascertained in step 317. For this purpose, a collision probability for the vehicle, which was ascertained, for example, in step 307, together with the surroundings model, is incorporated.

For the risk assessment 317, a status 319 of the restraint system, in particular, is also incorporated.

Multiple injury-mitigating measures are carried out depending on the ascertained effectiveness parameter. For example, an injury-mitigating measure may be a warning 321 which is output to the driver or to the vehicle occupants of the vehicle. A further injury-mitigating measure is, for example, an intervention 323 in the vehicle functions of the vehicle. This means that, according to measure 323, an intervention in a vehicle guidance, for example, a vehicle longitudinal guidance and/or a vehicle transverse guidance, is carried out. If a collision is detected in a step 325, an intervention in the restraint system and/or in further vehicle components takes place, as the injury-mitigating measure, in a step 327.

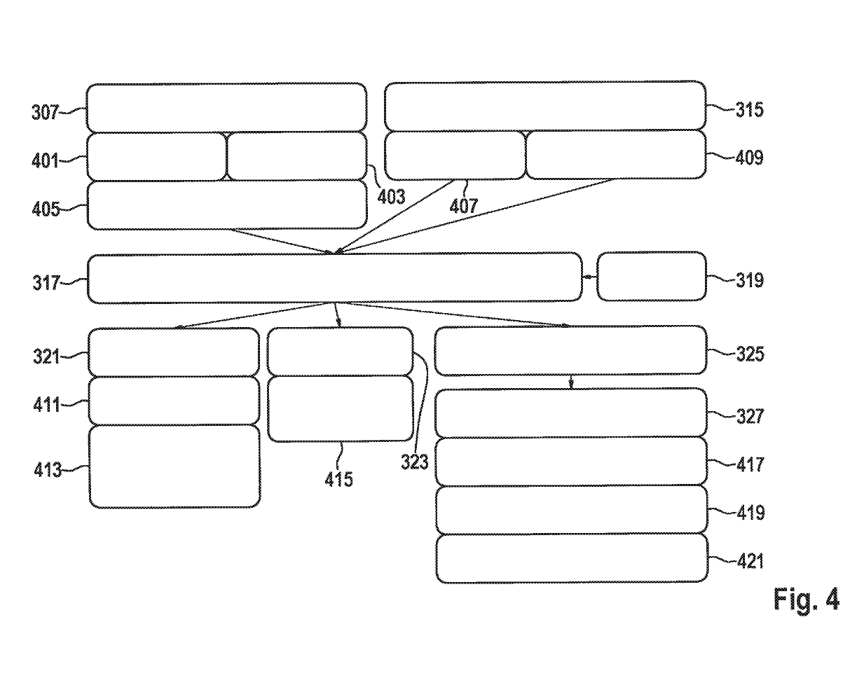

FIG. 4 shows a block diagram of a further method for operating a vehicle. In this case, the block diagram according to FIG. 4 is based on the block diagram according to FIG. 3 and expands upon this as follows, whereby not all steps or components of the block diagram according to FIG. 3 are shown in FIG. 4, for the sake of clarity.

In this way, surroundings model 307 includes, for example, a vehicle speed 401 and/or vehicle speeds of further vehicles in the surroundings of the vehicle. In particular, surroundings model 307 describes surroundings 403 and/or a location of the vehicle. Furthermore, a collision probability 405 with objects in the surroundings of the vehicle is ascertained.

The positions in which the individual vehicle occupants are situated is ascertained or detected, for example, in a step 407 for vehicle occupant model 315. It may be ascertained, for example, whether these occupants are situated outside of a predetermined position. This predetermined position generally exactly corresponds to the position in which a vehicle occupant must be situated so that the restraint system may deploy an optimal protective effect. In a step 409, it is ascertained, for example, whether or not an object in the vehicle interior limits a protective effect or an injury-mitigating effect of the restraint system. This takes place in a step 409.

The aforementioned information from surroundings model 307 and vehicle occupant model 315 are therefore incorporated, in particular, into the risk assessment according to step 317.

Warning 321 may be, for example, a warning that the vehicle occupants are situated outside of the predetermined position. Therefore, the vehicle occupants may be advantageously warned that they are no longer in a position in which an optimal protective effect may be effectuated with the aid of the restraint system in the event of a collision. This warning is labeled in FIG. 4 using reference numeral 413.

Warning 321 may be, for example, a warning 413 which warns that objects are located in the vehicle interior which may limit a protective effect of the restraint system.

An intervention in driving functions according to step 323 may be, for example, a prompt to take over and deactivate an automated driving operation. This intervention is labeled symbolically using reference numeral 415.

The intervention in the restraint system according to step 327 may be, for example, a positioning 417 of the vehicle occupant or the vehicle occupants by adjusting the corresponding vehicle seat and/or by tightening the corresponding seat belt. Therefore, a seat belt tightener is activated, for example, in step 417.

Intervention 327 may be, for example, a positioning 419 of interior components such as, for example, a steering wheel, vehicle pedals and/or displays, i.e., screens.

The intervention according to step 327 may further include an activation 421 of the restraint system. For example, a stronger effect for a seat belt may be set, which means that the seat belt is tightened to a greater extent than usual. For example, adaptation 421 may be that an airbag is deactivated or is inflated with reduced dynamics.

In summary, the present invention includes, in particular, the concept of ascertaining a situation for vehicle occupants of an autonomously driving vehicle with the aid of a surroundings sensor system and a vehicle interior sensor system and, optionally, additional communications technology such as C2X communication, for estimating, on the basis thereof, a risk for a possibly reduced performance or effectiveness of the restraint system in the event of a collision (ascertaining an effectiveness parameter) and for initiating measures which are suitable therefor (injury-mitigating measures), such as, for example, warnings or interventions in the protective or driving functions.

The core of the present invention is, in particular, a preferably good and early risk assessment of a collision probability in combination with a risk assessment as to whether passive safety means for the vehicle occupants are not optimally available.

The advantage which results therefrom, for example, is an optimal combination of a good protective effect of the passive safety and preferably great freedom for the driver, in particular, in the automated driving operation. This function may also be used for the other occupants (except for the driver) during non-automated travel. Likewise for the driveR, if he does not pay sufficient attention to his driving task during conventional travel.

Therefore, in summary, safety, in particular, is increased for the occupants during automated driving due to comprehensible and perceptible interventions of the vehicle: The vehicle thinks, so to speak, along with the vehicle occupant and tells him which things or actions the vehicle occupant is allowed to do and which he is not allowed to do, so that his safety is not reduced.

The advantage, in particular, of a perceptible user benefit by permitting preferably great degrees of freedom for the driver or for the vehicle occupants during an automated driving operation, without reducing safety, is effectuated, so that an increase in end-user acceptance for automated driving is effectuated.

1.-11. (canceled)

12. A method for operating a vehicle, comprising:
ascertaining a collision probability for the vehicle;
ascertaining an effectiveness parameter assigned to a restraint system of the vehicle, wherein the effectiveness parameter is a measure of how effectively the restraint system may protect a vehicle occupant in the event of a collision assigned to the collision probability; and
carrying out at least one injury-mitigating measure depending on the ascertained effectiveness parameter in order to reduce an occupant injury during a collision.

13. The method as recited in claim 12, further comprising:
detecting a vehicle interior state of a vehicle interior, wherein the effectiveness parameter is ascertained on the basis of the detected vehicle interior state.

14. The method as recited in claim 12, further comprising:
detecting a vehicle occupant state of a vehicle occupant, wherein the effectiveness parameter is ascertained on the basis of the detected vehicle occupant state.

15. The method as recited in claim 12, further comprising:
detecting a dynamic vehicle parameter, wherein the effectiveness parameter is ascertained on the basis of the detected dynamic vehicle parameter.

16. The method as recited in claim 12, wherein the carrying out of the at least one injury-mitigating measure includes one of deactivating an airbag and inflating the airbag during the collision on the basis of dynamics that are less than a predetermined dynamics threshold value.

17. The method as recited in claim 12, further comprising:
during automated guidance of the vehicle, carrying out, as an injury-mitigating measure, a take-over prompt to a driver for a guidance of the vehicle.

18. The method as recited in claim 17, wherein the take-over prompt includes at least one of an actuation of a seat of the driver and an actuation a seat belt of the driver.

19. The method as recited in claim 18, wherein, via the actuation, the driver is moved into a changed sitting position as compared to a sitting position before the actuation.

20. The method as recited in claim 17, wherein the take-over prompt includes an extension of at least one of a foot pedal and a steering wheel from a retracted position.

21. A device for operating a vehicle, comprising:
an arrangement for ascertaining a collision probability for the vehicle;
an arrangement for ascertaining an effectiveness parameter assigned to a restraint system of the vehicle, wherein the effectiveness parameter is a measure of how effectively the restraint system may protect a vehicle occupant in the event of a collision assigned to the collision probability; and
an arrangement for carrying out at least one injury-mitigating measure depending on the ascertained effectiveness parameter in order to reduce an occupant injury during a collision.

22. A computer program including program code for carrying out, when the computer program is run on a computer, a method for operating a vehicle, comprising:
ascertaining a collision probability for the vehicle;
ascertaining an effectiveness parameter assigned to a restraint system of the vehicle, wherein the effectiveness parameter is a measure of how effectively the restraint system may protect a vehicle occupant in the event of a collision assigned to the collision probability; and
carrying out at least one injury-mitigating measure depending on the ascertained effectiveness parameter in order to reduce an occupant injury during a collision.
